(19) United States
(12) Patent Application Publication
(10) Pub. No.: US 2006/0086213 A1
(43) Pub. Date: Apr. 27, 2006

(54) Screw driver structure

(76) Inventor: Fu-Hsiung Wu, Taishan Township (TW)

Correspondence Address: APEX JURIS, PLLC, LAKE CITY CENTER, SUITE 410, 12360 LACE CITY WAY NORTHEAST, SEATTLE, WA, 98125, US

(21) Appl. No.: 10/974,439

(22) Filed: Oct. 26, 2004

(51) Int. Cl. B25B 23/08

(52) U.S. Cl. 81/451

(57) ABSTRACT

A screw driver structure includes a shank and a compression ring. The compression ring houses a compression spring which is tightly coupled on the shank to allow the compression ring to move relative to the shank. When the shank is turned to drive a screwing element, the compression ring may be adjusted according to the position of the screwing element so that the compression ring can compress the coupling surface of the screwing element to give the entire coupling surface a vertical and downward action force to prevent the screwing element from wobbling sideward and enable users to fasten the screwing element single-handed.

### FIELD OF THE INVENTION

The present invention relates to a screw driver structure for fastening screws and particularly to a screw driver structure that has a movable compression ring to generate a vertical and downward action force on the coupling surface of the screws.

### BACKGROUND OF THE INVENTION

Screws and nuts are commonly used coupling elements to fasten two objects securely. The fastening operation is generally accomplished by using a hand tool such as a screw driver or an automatic tool (electric or pneumatic tools). There are many types of screw drivers on the market. They mostly include a handle and a bit. The bit may be formed in different shapes of tips according to different types of screws and nuts, such as a cabinet tip, Philips head tip, polygonal tip, sleeve tip, or the like.

More convenient user operation has been researched and development of hand tools such as the screw drivers has been researched as well. For instance, R.O.C. patent publication No. 538858 entitled “Improved screw driver structure” discloses a design that has a selected number of apertures on the distal end of the handle of a screw driver to couple with a rod to facilitate turning and driving of the screws. The apertures also allow the screw driver to be hung on a wall to make storing more convenient. Another example is R.O.C. patent publication number 492393 entitled “Screw driver equipped with a lighting structure” which couples a screw driver with a lighting feature so that it provides illumination for users when using the screw driver in a dark environment, to improve operation convenience.

Many screw drivers now have a magnetic front end (i.e. the bit) to attract screws. However, when the magnetic screw driver turns the screw, the screw does not have any support, and often wobbles sideward. A user usually has to hold the screw with one hand and turn the screw driver with the other hand to fasten the screw into an object. This operation is inconvenient.

### SUMMARY OF THE INVENTION

In view of the aforesaid problems occurring to conventional techniques, the object of the present invention is to provide a screw driver structure to give the coupling surface of a screwing element (i.e. screw) a vertical and downward action force while driving so that the screwing element does not wobble sideward to enable the user to fasten or unfasten the screwing element single-handed.

The screw driver according to the invention includes three main portions: a shank, a compressing ring and a handle.

The shank has a driving section on the front end to wedge in the notch of the screwing element to fasten or unfasten the screwing element into or away from a screw hole of an object.

The compression ring is coupled on the shank abutting the driving section. It is magnetic and may be integrally formed on the periphery of the shank, or directly coupled on the shank.

The magnetic compression ring may adopt another design by coupling on the periphery of the shank and having a housing chamber inside to hold a compression spring. The compression ring has a first hole and a second hole on two ends that are slightly smaller than the housing chamber to confine the compression spring in the housing chamber. The shank can pass through the first and second holes. The compression spring has at least one bucking ring and one clipping ring. The bucking ring has an inner diameter greater than the inner diameter of the first hole to confine the compression spring in the housing chamber. The clipping ring has an inner diameter slightly smaller than the diameter of the shank to couple tightly on the shank. Thus the compressing ring is movable relative to the shank because of the electricity of the compression spring.

When a user uses the screw driver to turn a screwing element, he/she can adjust the compression ring according to the position of the screwing element so that one end of the compression ring presses the coupling surface of the screwing element and the magnetic force of the compression ring attracts the screwing element to give the entire coupling surface a vertical and downward action force to prevent the screwing element from wobbling sideward. Therefore the user can drive the screwing element single-handed, and operation convenience improves.

In addition, the location of the compression ring may be adjusted according to the notch depth of the screwing element to fully press the coupling surface of the screwing element to enhance using flexibility.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the first embodiment of the invention, partly cuts away;

FIG. 2 is a schematic view of the first embodiment of the invention, driving a screwing element;

FIG. 3 is an exploded view of the first embodiment of the invention;

FIGS. 4A and 4B are perspective views of the first embodiment of the invention with a lug on the shank to couple with the handle and an electric tool;

FIGS. 5A and 5B are an exploded view and a sectional view of the second embodiment of the invention;

FIGS. 6A and 6B are a perspective view of the third embodiment of the invention;

FIG. 7 is a schematic view of the screw driver of the invention driving a screwing element;

FIG. 8 is an exploded view of the third embodiment of the invention;

FIG. 9 is an exploded view of the shank coupling with an electric tool;

FIGS. 10A and 10B are an exploded view and a coupling view of the fourth embodiment of the invention;

FIGS. 11A and 11B are an exploded view and a coupling view of the fifth embodiment of the invention; and

FIG. 12 is a schematic view of the fifth embodiment of the invention in use condition.

### DESCRIPTION OF THE PREFERRED EMBODIMENTS

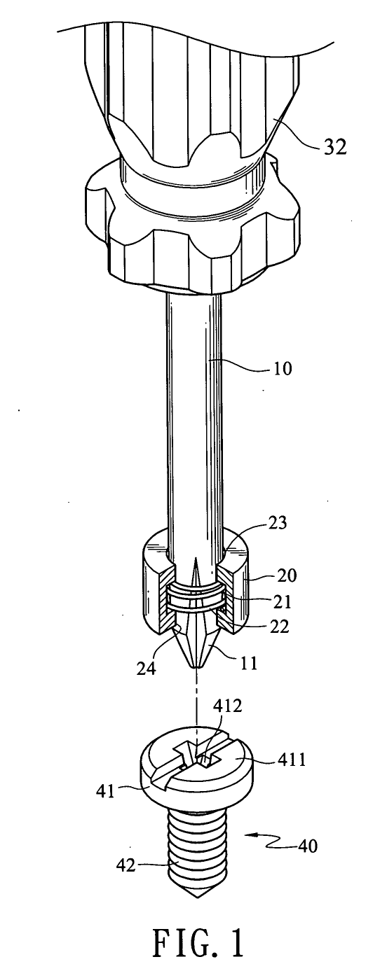

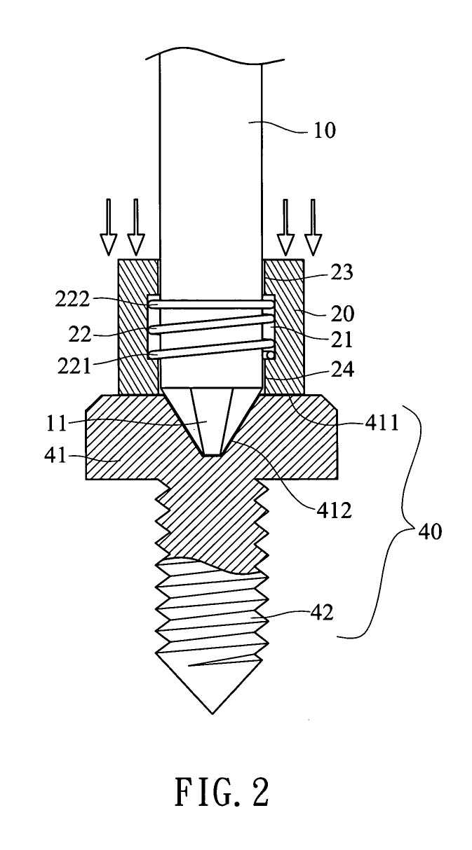

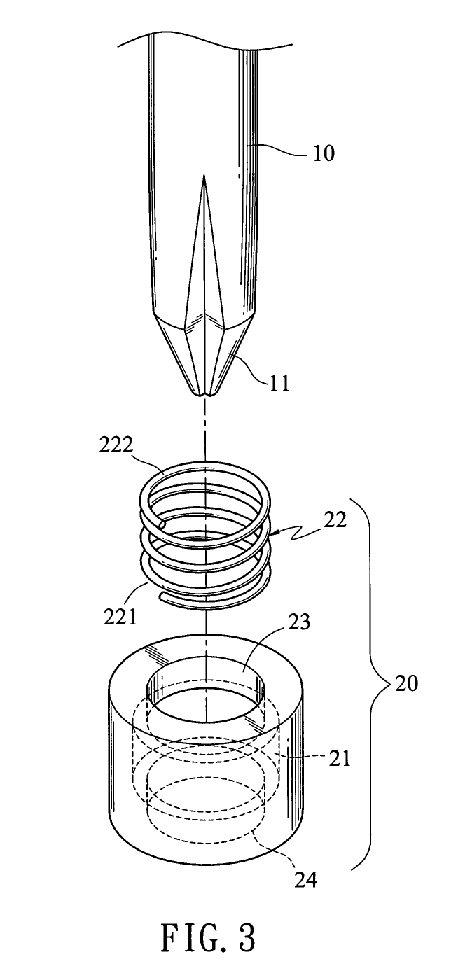

Refer to FIGS. 1, 2 and 3 for the first embodiment of the screw driver of the invention. It includes three main portions: a shank 10, a compression ring 20 and a handle 30. When in use, the compression ring 20 is fully pressed on the surface of a screwing element 40, and the handle 30 and the shank 10 coupled thereon are turned to drive the screwing element 40 into an object or unfasten the screwing element 40 from the object.

The screwing element 40, generally called the screw, includes a screw head 41 and a screw shank 42. The screw head 41 has a coupling surface 411 and a notch 412.

The shank 10 has a driving section 11 at the front end to wedge in the notch 412 of the screwing element 40 to turn and drive the screwing element 40 into a screw hole of an object to be coupled or away from the object to be separated.

The driving section 11 is magnetic to attract the screwing element 40. The driving section 11 may be formed with a tip of various shapes such as a cabinet tip, a Philips head tip, a polygonal tip, a sleeve tip, or the like to mate different types of screws and screw heads (not shown in the drawings).

The compression ring 20 is magnetic and coupled on the periphery of the shank 10 abutting the driving section 11. It has a housing chamber 21 formed inside to house a compression spring 22, a first hole 23 and a second hole 24 formed on two ends that are slightly smaller than the housing chamber 21, to confine the compression spring 22 in the housing chamber 21. The shank 10 runs through the first and second holes 23 and 24.

The compression ring 20 may be made from a magnetic material or be magnetized on the surface to become magnetic.

The compression spring 22 has at least one bucking ring 231 and one clipping ring 232. The bucking ring 231 has an inner diameter greater than the inner diameter of the first hole 23 to confine the compression spring 22 in the housing chamber 21. The clipping ring 232 has an inner diameter slightly smaller than the diameter of the shank 10 to couple on the shank 10 tightly. Because of the elasticity of the compression spring 22, the compression ring 20 is movable relative to the shank 10.

When a user turns the shank 10 to drive the screwing element 40, he/she can adjust the compression ring 20 according to the position of the screwing element 40 so that one end of the compression ring 20 presses the coupling surface 411 of the screwing element 40, and the magnetic force of the compression ring 20 attracts the screwing element 40 to give the entire coupling surface 411 a vertical and downward action force to prevent the screwing element 40 from wobbling sideward. Therefore the user can turn and drive the screwing element 40 with only one hand. This greatly improves operation convenience.

As the clipping ring 232 of the compression spring 22 is tightly coupled on the shank 10, when the compression ring 20 is no longer needed, it also may be removed by force so that the screw driver may become a general screw driver to enhance using flexibility.

In addition, the position of the compression ring 20 may be adjusted according to the depth of the notch 412 of the screwing element 40 to fully press the coupling surface 411 to increase using flexibility.

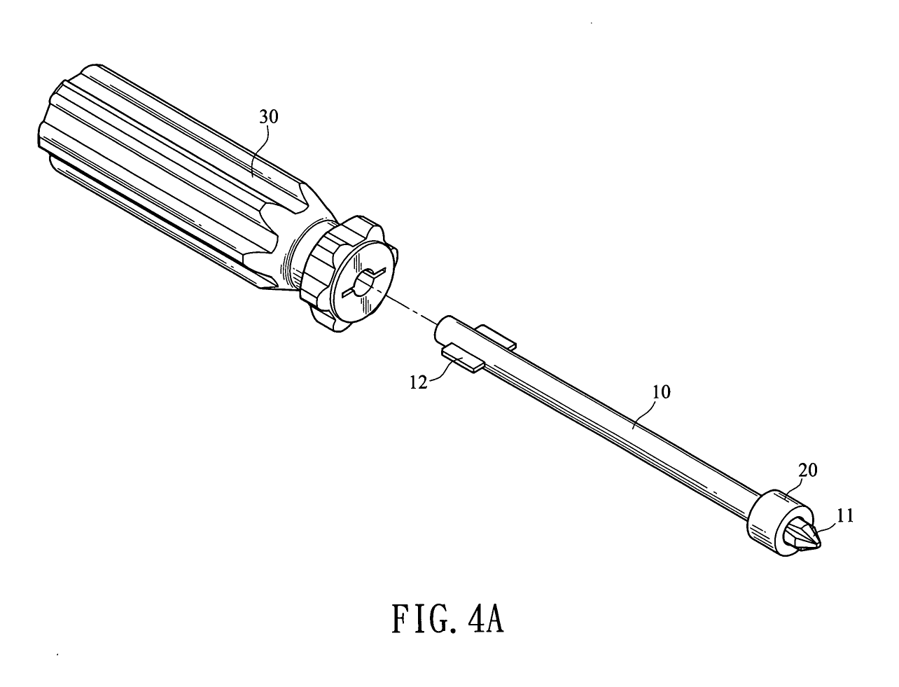

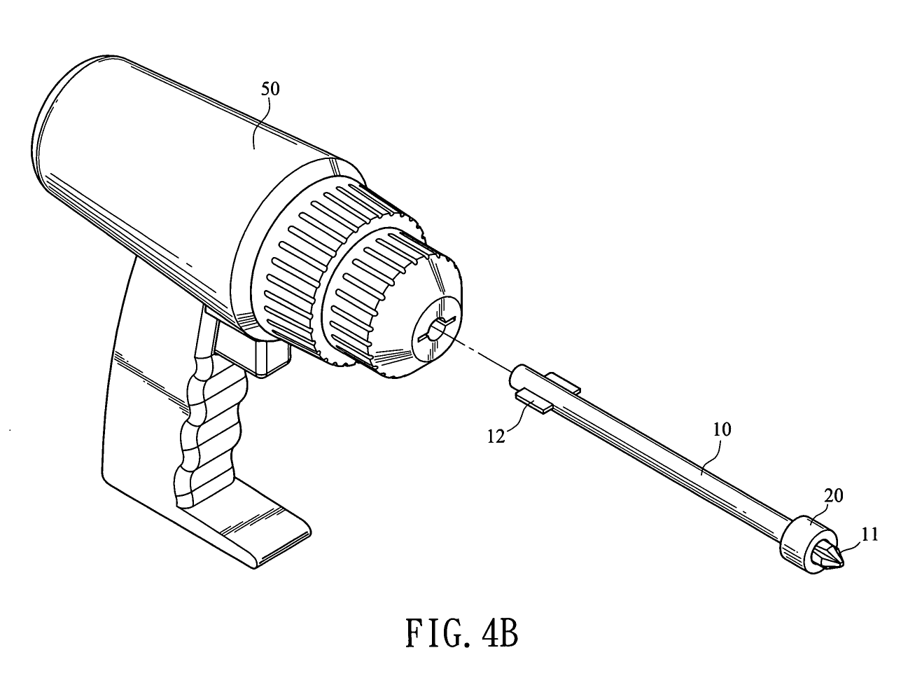

The shank 10 has one or more lugs 12 on the other end opposing the driving section 11 to facilitate coupling with the handle 30 or an electric tool 50 as shown in FIGS. 4A and 4B, to further enhance using convenience.

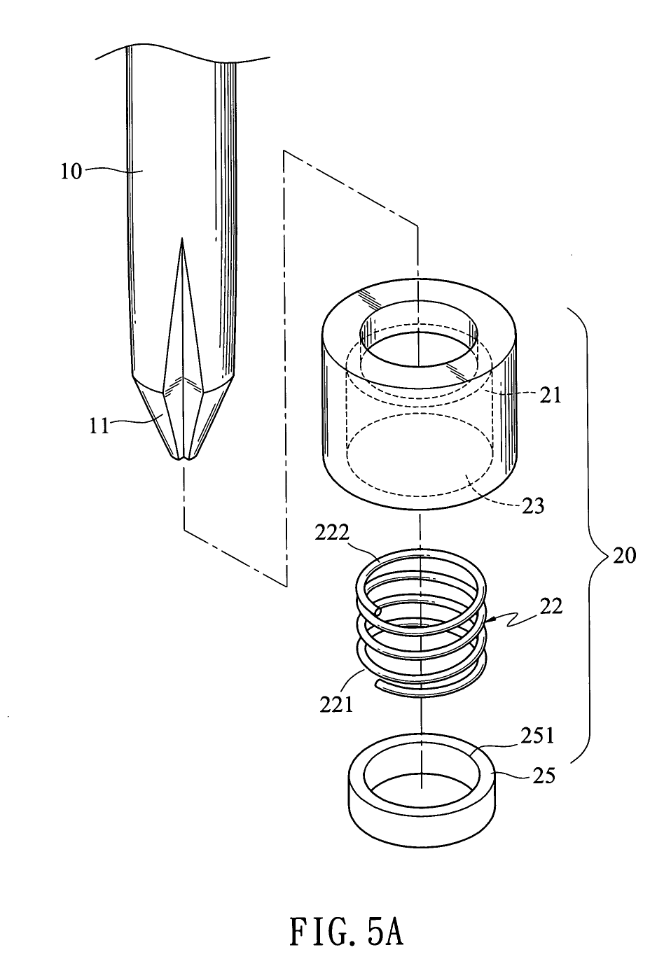

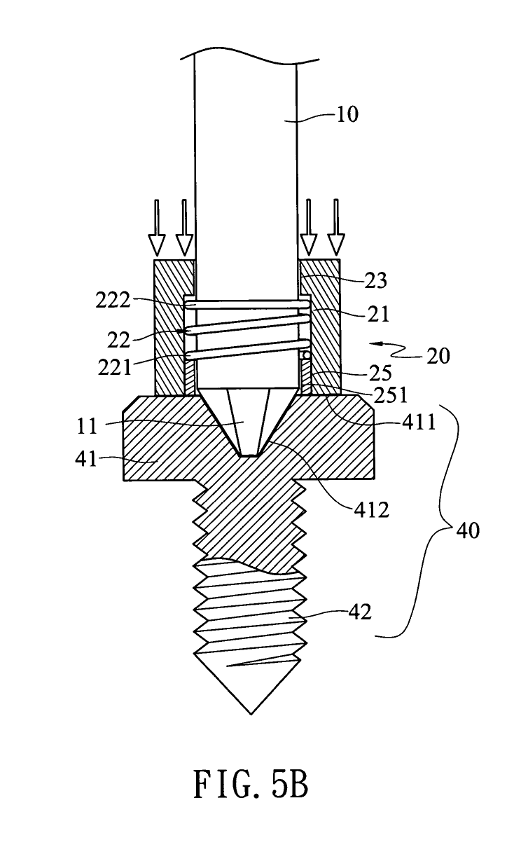

Refer to FIGS. 5A and 5B for a second embodiment of the invention. It is constructed largely like the first embodiment. The main difference is the inner structure of the compression ring 20.

The compression ring 20 is hollow and made of metal, and may be magnetic or non-magnetic. It also has a housing chamber 21 and a first hole 23 on one end slightly smaller than the housing chamber 21. It has a magnetic retaining ring 25 on the other end that has a second hole 251 corresponding to the first hole 23 and has the same inner diameter as the first hole 23, to allow the shank 10 to run through the first and second holes 23 and 251.

The compression spring 22 is held in the housing chamber 21. It also has at least one bucking ring 221 and one clipping ring 222. The bucking ring 221 has an inner diameter greater than the inner diameter of the first hole 23, to confine the compression spring 22 in the housing chamber 21. The clipping ring 222 has an inner diameter slightly smaller than the diameter of the shank, 10 to tightly couple on the shank 10. Because of the compression spring 22, the compression ring 20 is movable relative to the shank 10. The compression spring 22 may be a conical compression spring.

When a user turns the shank 10 to drive the screwing element 40, he/she also can adjust the compression ring 20 according to the position of the screwing element 40 so that the retaining ring 25 presses the coupling surface 411 of the screwing element 40, and the magnetic force of the retaining ring 25 attracts the screwing element 40 to give the entire coupling surface 411 a vertical and downward action force, to prevent the screwing element 40 from wobbling sideward. Thus the user can operate more conveniently.

Moreover, the position of the compression ring 20 may also be adjusted according to the depth of the notch 412 of the screwing element 40 so that the retaining ring 25 can fully press the coupling surface 411 of the fastening element 40 to increase using flexibility.

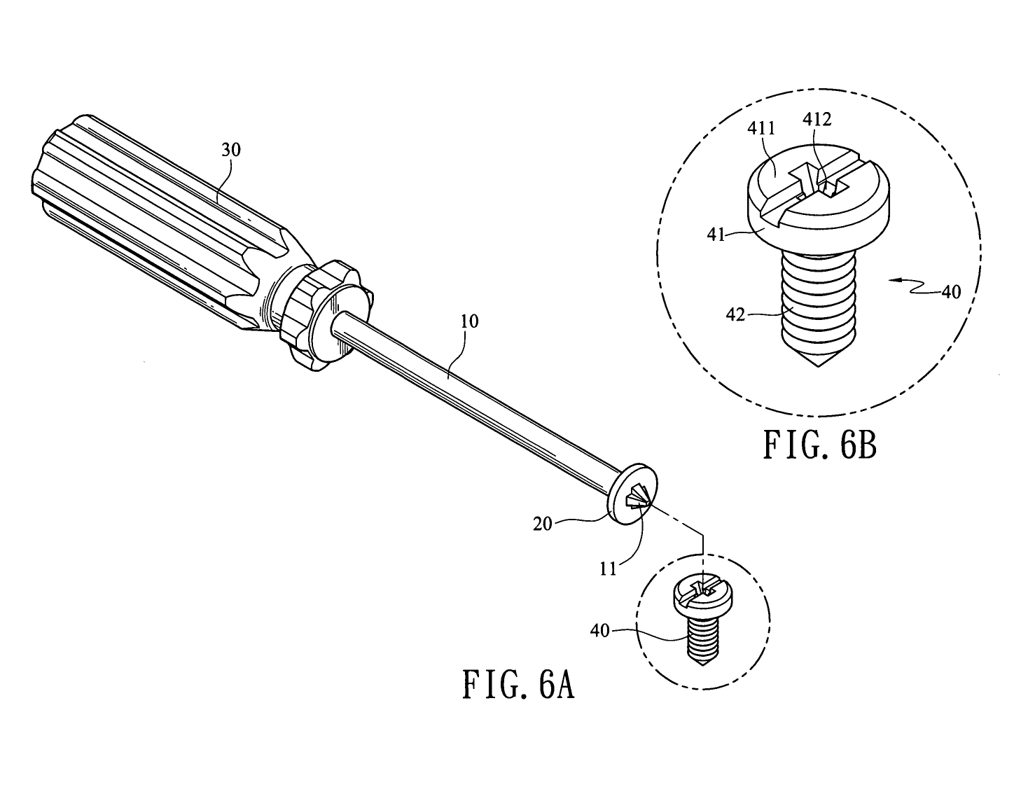

Refer to FIGS. 6A and 6B for a third embodiment of the invention. The screw driver includes three main portions: a shank 10, a compression ring 20 and a handle 30. When in use, the compression ring 20 is fully pressed on the surface of a screwing element 40, and the handle 30 and the coupled shank 10 may be turned to drive the screwing element 40 into an object or unfasten the screwing object 40 from the object.

The screwing object 40, generally called the screw, includes a screw head 41 and a screw shank 42. The screw head 41 has a coupling surface 411 and a notch 412.

The shank 10 has a driving section 11 at the front end to wedge in the notch 412 of the screwing element 40 to turn and drive the screwing element 40 into a screw hole of an object to be coupled or to be away from the object to be separated.

The driving section 11 is magnetic to attract the screwing element 40. The driving section 11 may be formed with a tip of various shapes such as a cabinet tip, a Philips head tip, a polygonal tip, a sleeve tip, or the like to mate different types of screws and screw heads (not shown in the drawings).

The compression ring 20 is magnetic and integrally coupled on the shank 10 abutting the driving section 11.

The compression ring 20 may be made from a magnetic material or be magnetized on the surface to become magnetic.

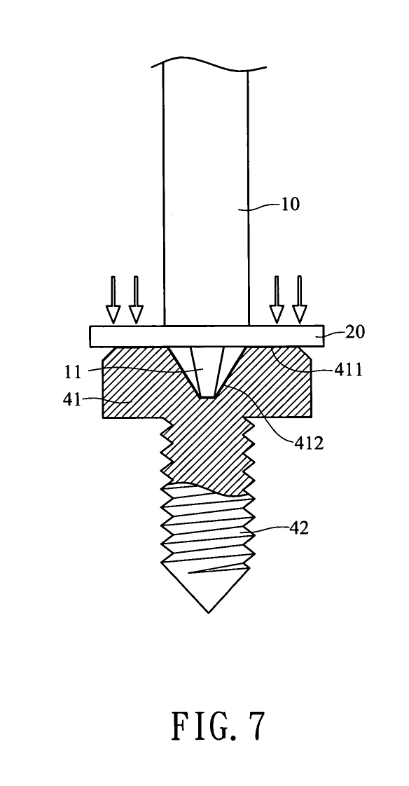

Referring to FIG. 7, when a user wants to use the screw driver to turn the screwing element 40, he/she wedges the driving section 11 of the shank 10 in the notch 412 of the screwing element 40. As the compression ring 20 is magnetic, it attracts the screwing element 40 and gives the entire coupling surface 411 a vertical and downward action force to prevent the screwing element 40 from wobbling sideward. Therefore, the user can turn and drive the screwing element 40 with only one hand. This greatly improves operation convenience.

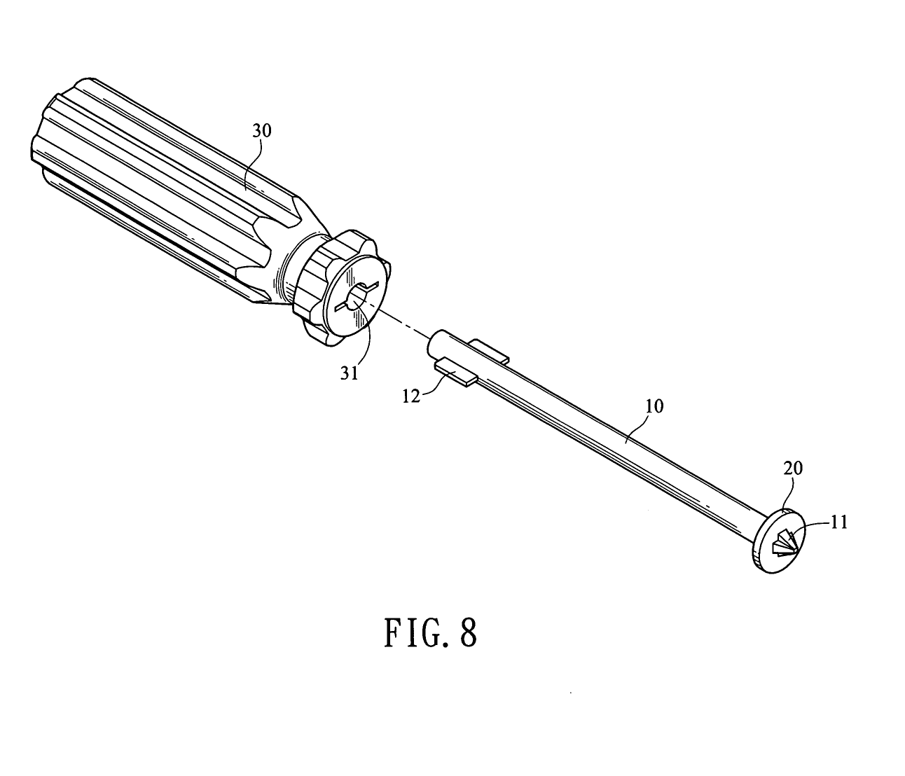

Referring to FIG. 8, the shank 10 and the handle 30 may be separated. The shank 10 has one or more lugs 12 on the other end to be inserted into a corresponding trough 31 formed in the handle 30 for coupling therewith.

For changing different types of driving section 11, the shank 10 with the lug 12 may be removed from the trough 31 of the handle 30, and another shank 10 with a different driving section 11 may be coupled with the handle 30 again for use.

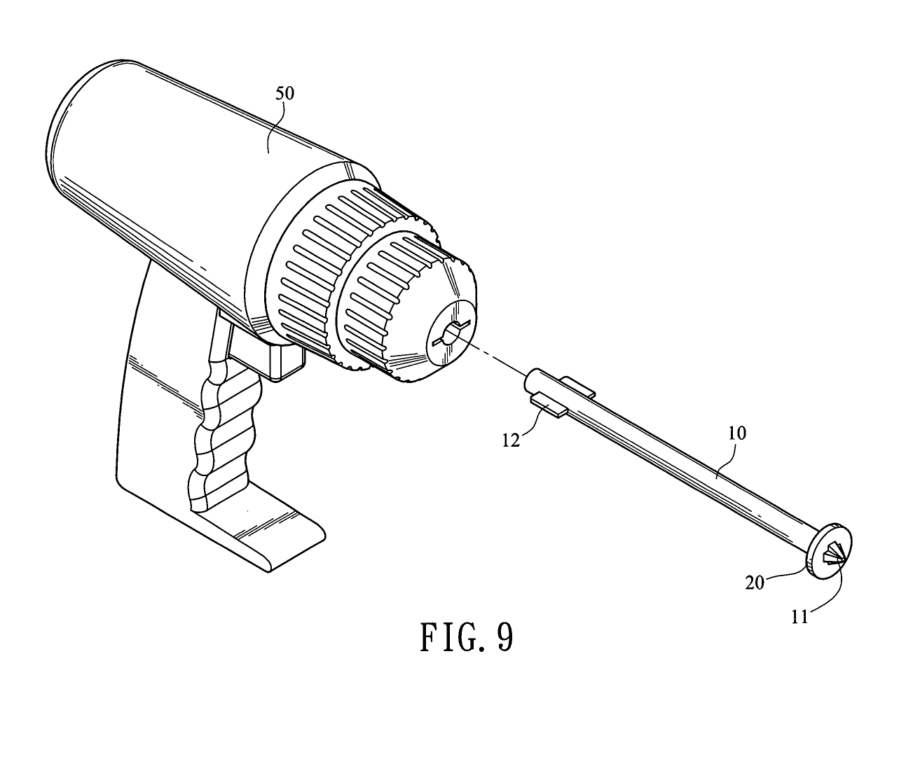

Referring to FIG. 9, the shank 10 with the lug 12 may also be coupled with an electric tool 50 which can drive and turn the screwing element 40 without using manpower, thus operation convenience greatly improves.

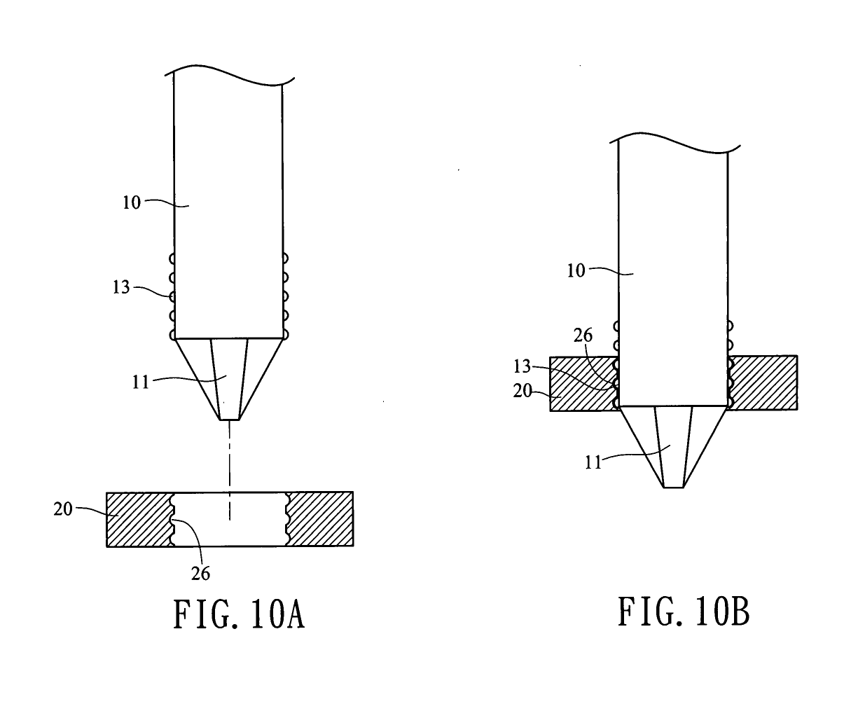

Refer to FIGS. 10A and 10B for a fourth embodiment of the invention. It is constructed largely like the third embodiment. However, the shank 10 and the compression ring 20 are rather separated than integrally formed.

The shank 10 has one or more ribs 13 formed on a location close to the driving section 11. The compression ring 20 has a fastening groove 26 mating the rib 13 so that the compression ring 20 may be coupled with the shank 10 at a desired location when needed.

For turning the screwing element 40 of a different type or size, the compression ring 20 may be adjusted to couple the fastening groove 26 with a rib 13 located on a different position to alter the relative length of the compression ring 20 and the front end of the driving section 11 so that the compression ring 20 can fully press the coupling surface 411 of the screwing element 40.

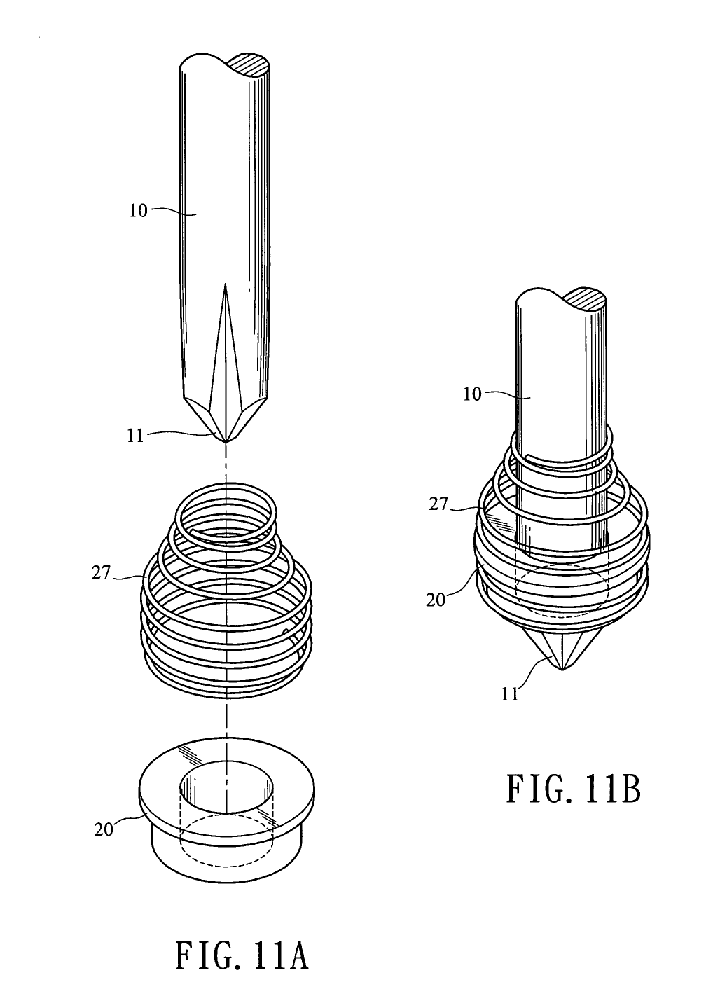

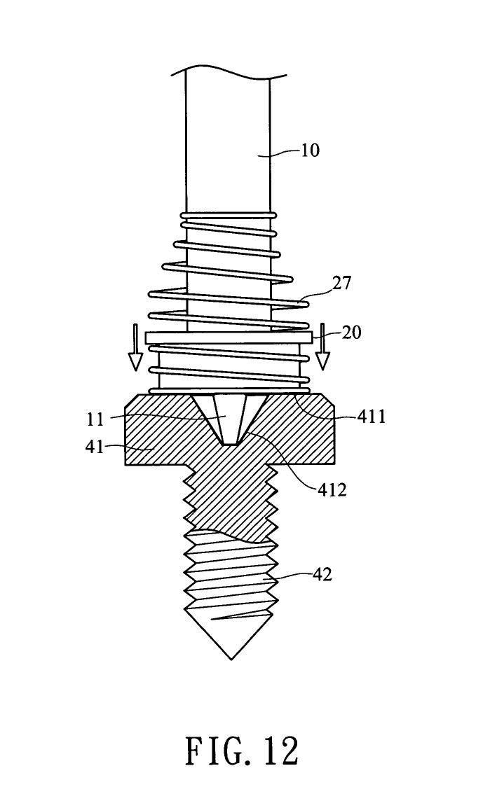

Refer to FIGS. 11A and 11B for a fifth embodiment of the invention. It includes a shank 10, a compression ring 20, a handle 30 and a spring 27.

The shank 10 has a driving section 11 at the front end to wedge in a notch 412 of a screwing element 40 to turn and drive the screwing element 40 into a screw hole of an object to be coupled or to be away from the object to be separated.

The driving section 11 is magnetic to attract the screwing element 40. The driving section 11 may be formed with a tip of various shapes such as a cabinet tip, a Philips head tip, a polygonal tip, a sleeve tip, or the like to mate different types of screws and screw heads (not shown in the drawings).

The compression ring 20 is magnetic and abutting the driving section 11 to attract the screwing element 40, and is movable on the shank 10 to press a coupling surface 411 of the screwing element 40.

The spring 27 is coupled on the periphery of the compression ring 20 and has one end remote from the driving section 11 coupled tightly on the shank 10 for anchoring the spring 27.

The position of the compression ring 20 may be changed through compression or extension of the spring 27 to mate different depths of the notch 412 of the screw head 41 so that the compression ring 20 can fully press the coupling surface 411 of different types of screwing elements 40.

As the spring 27 has one end tightly coupled on the shank 10, when the compression ring 20 and the spring 27 are no longer needed, they may be removed by force to use the screw driver as a general one to increase using flexibility.

The shank 10 also has a lug 12 on one end opposing the driving section 11 to facilitate coupling with the handle 30 or an electric tool 50 (not shown in the drawings) to enhance using flexibility.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A screw driver structure for turning and driving a screwing element which has a coupling surface and a notch, comprising:
a shank having a driving section on one end to wedge in the notch; and
a magnetic compression ring coupled on the periphery of the shank having a spring located therein to couple tightly on the shank to allow the compression ring to be movable relative to the shank and make one end of the compression ring to compress the coupling surface.

2. The screw driver structure of claim 1, wherein the driving section is magnetic.

3. The screw driver structure of claim 1, wherein the one end of the compression ring to compress the coupling surface is magnetic.

4. The screw driver structure of claim 1, wherein the shank has at least one lug on the other end to couple with a handle of the screw driver structure.

5. The screw driver structure of claim 1, wherein the shank has at least one lug on the other end to couple with an electric tool.

6. A screw driver structure for turning and driving a screwing element which has a coupling surface and a notch, comprising:
a shank having a driving section on one end to wedge in the notch; and
a hollow compression ring made of metal having a housing chamber in the interior, a first hole on one end smaller than the housing chamber and a magnetic retaining ring located on the other end, the retaining ring having a second hole corresponding to the first hole with the same diameter to allow the shank to pass through the first hole and the second hole; and
a compression spring located in the housing chamber having at least one bucking ring and one clipping ring, and the bucking ring having an inner diameter greater than the inner diameter of the first hole to confine the compression spring in the housing chamber, and the clipping ring having an inner diameter smaller than the diameter of the shank to tightly couple on the shank so that the compressing ring is movable relative to the shank to compress the coupling surface.

7. The screw driver structure of claim 6, wherein the driving section is magnetic.

8. The screw driver structure of claim 6, wherein the compression ring is magnetic.

9. The screw driver structure of claim 6, wherein the shank has at least one lug on the other end to couple with a handle of the screw driver structure.

10. The screw driver structure of claim 6, wherein the shank has at least one lug on the other end to couple with an electric tool.

11. A screw driver structure for turning and driving a screwing element which has a coupling surface and a notch, comprising:
a shank having a driving section on one end to wedge in the notch; and
a magnetic compression ring integrally formed with the shank abutting the driving section to compress the coupling surface.

12. The screw driver structure of claim 11, wherein the driving section is magnetic.

13. The screw driver structure of claim 11, wherein the shank has at least one lug on the other end to couple with a handle of the screw driver structure.

14. The screw driver structure of claim 11, wherein the shank has at least one lug on the other end to couple with an electric tool.

15. A screw driver structure for turning and driving a screwing element which has a coupling surface and a notch, comprising:
a shank having a driving section on one end to wedge in the notch and a rib abutting the driving section; and
a magnetic compression ring having a fastening groove corresponding to the rib to couple with the shank to allow the compression ring to compress the coupling surface.

16. The screw driver structure of claim 15, wherein the driving section is magnetic.

17. The screw driver structure of claim 15, wherein the shank has at least one lug on the other end to couple with a handle of the screw driver structure.

18. The screw driver structure of claim 16, wherein the shank has at least one lug on the other end to couple with an electric tool.

19. The screw driver structure of claim 15, wherein the shank has at least one rib, and the magnetic compression ring has a fastening groove, so the rib matches the fastening groove to anchor the compression ring on a selected location of the shank when the compression ring is on the shank.

20. A screw driver structure for turning and driving a screwing element which has a coupling surface and a notch, comprising:
a shank having a driving section on one end to wedge in the notch;
a magnetic compression ring abutting the driving section to compress the coupling surface; and
a spring coupled on the periphery of the compression ring to make the compression ring movable according to the depth of the notch, and having one end remote from the driving section tightly coupled and anchored on the shank.

21. The screw driver structure of claim 20, wherein the driving section is magnetic.

22. The screw driver structure of claim 20, wherein the shank has at least one lug on the other end to couple with a handle of the screw driver structure.

23. The screw driver structure of claim 20, wherein the shank has at least one lug on the other end to couple with an electric tool.
